(19) United States
(12) Patent Application Publication
(10) Pub. No.: US 2017/0045977 A1
(43) Pub. Date: Feb. 16, 2017

(54) Mobile Terminal

(71) Applicant: Qu HE, Taizhou, Zhejiang (CN)

(72) Inventor: Qu HE, Taizhou, Zhejiang (CN)

(21) Appl. No.: 15/305,298

(22) PCT Filed: Feb. 26, 2015
(86) PCT No.: PCT/CN2015/073288

§ 371 Date: Oct. 19, 2016

(30) Foreign Application Priority Data
Apr. 22, 2014 (CN) 201420198153.7

(51) Int. Cl. G06F 3/041; G06F 3/0346; G06F 1/16; G06F 3/0488

(52) U.S. Cl. CPC G06F 3/0414; G06F 3/04886; G06F 3/0346; G06F 1/1626; G06F 2203/04105

(57) ABSTRACT

Provided is a mobile terminal, which at least comprises a touchscreen, a processor and at least one pressure sensor, wherein the pressure sensor is arranged on the back of the mobile terminal. The present invention can adjust a virtual key in the touchscreen and a display region of an application program icon according to a pressure signal sensed by the pressure sensor, so that the virtual key and the application program icon are located in a region facilitating a user in conducting touch control. Therefore, by means of the present invention, it is not necessary for a user to change the posture of his/her hand any longer, so that the user can easily click all virtual keys and application program icons, thereby having good usage experience.

### FIELD OF THE INVENTION

The present invention relates to the technical field of a touch screen device, in particular, relates to a mobile terminal.

### BACKGROUND OF THE INVENTION

With the development of science and technology, the size of the touch screen in mobile terminals like telephones gets bigger and bigger.

Bigger size touch screen brings more contents to be shown, at the same time, brings better viewing and gets more favor from public.

However, because touch screen have both function of showing and receiving, bigger size touch screen brings more difficult operation to users. Like when the size is too bigger, it is not easy for a user to make his fingers touch all region of the touch screen, in the condition when he only uses one of his hands to hold the mobile terminal. For example, for a user, his left hand thumb can easily touch the right and lower part region of a touch screen, but difficult to touch upper and left part region. So it requires a user to change his posture in holding the mobile terminal to touch all part region.

### SUMMARY OF THE INVENTION

Embodiments of the present invention provide a mobile terminal, so that the user can easily click all virtual keys and application program icons.

To arrive at the present application, embodiments of the present application disclose a mobile terminal. The mobile terminal comprises a touchscreen, a processor and at least one pressure sensor, the processor is separately linked with the touch screen and pressure sensor. And the pressure sensor is arranged on the back of the mobile terminal.

To be preferred, at least one pressure sensor is arranged in the position of the lower and left part region of the back of the mobile terminal.

To be preferred, at least one pressure sensor is arranged in the position of the lower and right part region of the back of the mobile terminal.

To be preferred, the mobile terminal further comprises: gravity sensor, which is linked with the processor.

To be preferred, the pressure sensor is arranged on the back shell of the mobile terminal.

To be preferred, the pressure sensor is arranged on the back mainboard of the mobile terminal.

To be preferred, through-holes are set in the back shell of the mobile terminal. One side of the pressure sensor crosses at them.

To be preferred, flexible mechanisms are set on the back shell of the mobile terminal. One side of the pressure sensor faces with them.

The present invention provides a mobile terminal, which at least comprises a touchscreen, a processor and at least one pressure sensor, wherein the pressure sensor is arranged on the back of the mobile terminal. The present invention can adjust a virtual key in the touchscreen and a display region of an application program icon according to a pressure signal sensed by the pressure sensor, so that the virtual key and the application program icon are located in a region facilitating to a user in conducting touch control. Therefore, by means of the present invention, it is not necessary for a user to change the posture of his/her hand any longer, so that the user can easily click all virtual keys and application program icons, thereby having good usage experience.

### BRIEF DESCRIPTION OF FIGURES

To better describe Embodiments of the invention and the technical proposal existed in the prior art, summary introduction for the figures used in the Embodiments and the prior art is made. Obvious, figures being described in the following is just a part of the present invention, and for persons of ordinary skill in the art, modifications may be made to obtain other figures according to our figures without inventive labor.

FIG. 1 is the front view of the mobile terminal provided by the present invention Embodiment.

FIG. 2 is the rear view of the mobile terminal provided by the present invention Embodiment.

FIG. 3 is the rear view of another mobile terminal provided by the present invention Embodiment.

FIG. 4 is the rear view of another mobile terminal provided by the present invention Embodiment.

FIG. 5 shows the figure of the lighting region of virtual keys and application program.

FIG. 6 shows another figure of the lighting region of virtual keys and application program.

FIG. 7 is the display interface of the application program of mobile terminal existed in the prior art provided by the embodiment of the present invention.

FIG. 8 is the display interface of the application program of mobile terminal provided by the present invention.

FIG. 9 shows another figure of the lighting region of virtual keys and application program icons.

### DETAILED DESCRIPTION OF THE EMBODIMENTS

The technical proposal combining figures in the Embodiment of the present invention is described in detail as below. Obvious, Embodiment described in the following is just a part not the complete of the present invention, and for persons of ordinary skill in the art, other Embodiment may be made and obtained without inventive labor, and should be regarded fall into the scope of the present invention.

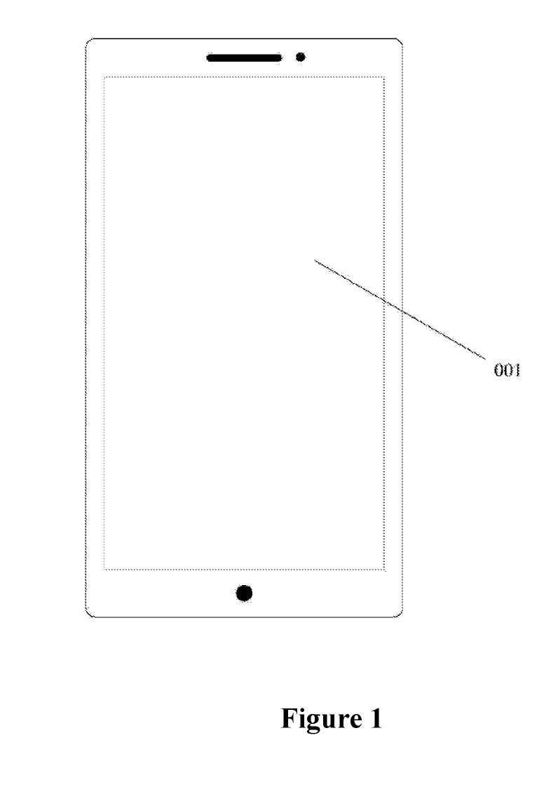

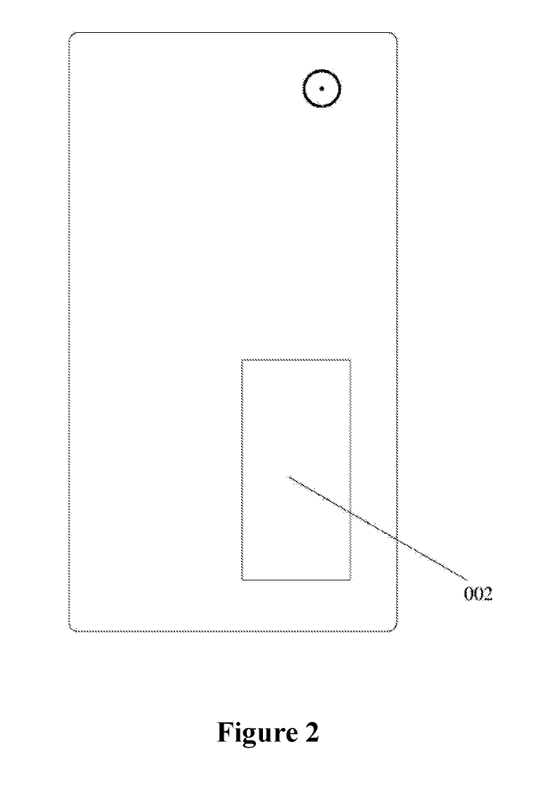

Combining FIG. 1 and FIG. 2, the mobile terminal provided by the Embodiment of the present invention, at least comprises: touching screen 001, processor (not showing in FIG. 1 and FIG. 2) and at least one pressure sensor 002. The processor is linked with the touch screen 001 and pressure sensor 002. The pressure sensor 002 is arranged on the back of the mobile terminal.

It can be understood, the pressure sensor 002 can sense pressure signal, and then send it to the processor. Therefore, processor can determine the lighting region of virtual keys and application program icons of touch screen 001 according to the pressure signal.

Preferred, as shown by FIG. 2, at least one pressure sensor 002 is arranged in the position of the lower and left part region of the back of the mobile terminal.

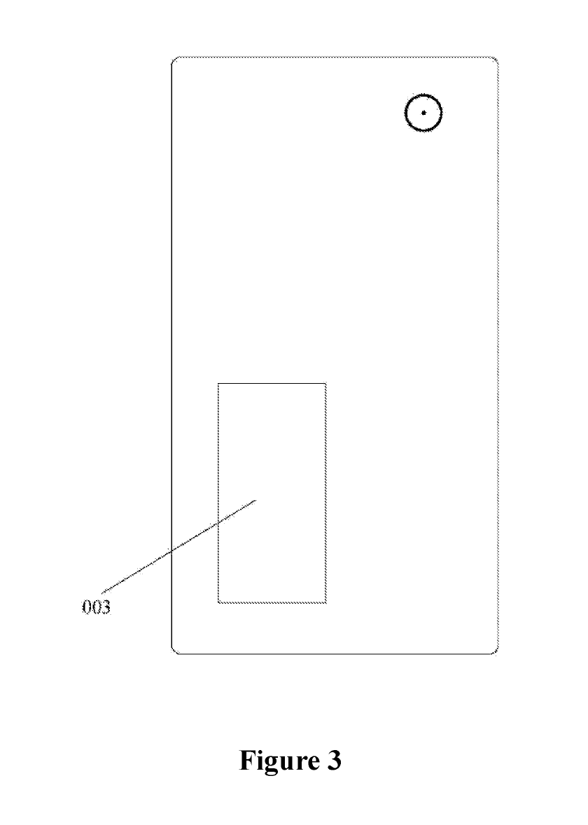

Of course, as shown by FIG. 3, at least one pressure sensor 003 is arranged in the position of the lower and right part region of the back of the mobile terminal.

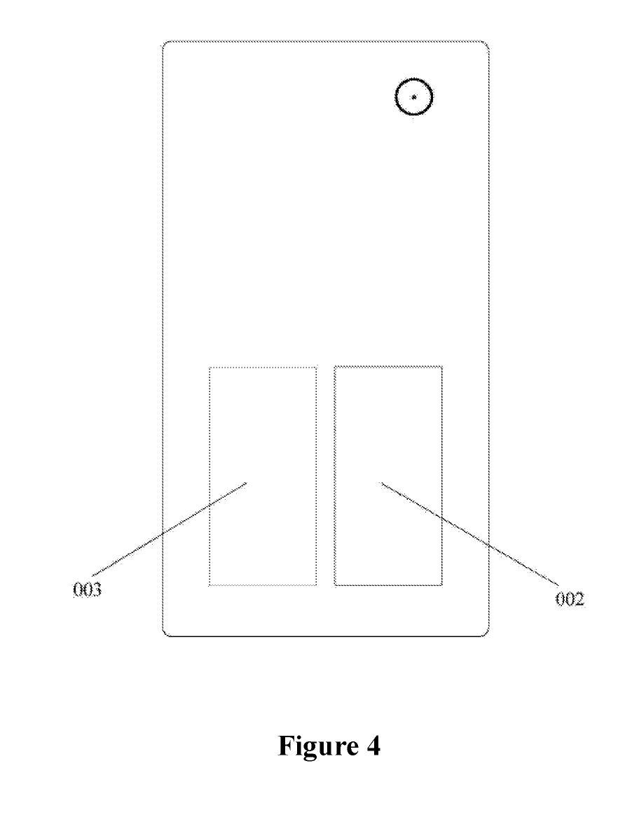

Further, as shown by FIG. 4, in other embodiment of the present invention, at least one pressure sensor is arranged in the position of the lower, right and left part region of the back of the mobile terminal at the same time.

It can be understood, when a user uses his single hand to operate mobile terminal, his fingers like thumb will become bending to some extent. And other fingers especially finger prominence except thumb will touch the back of the mobile terminal. So this touching part region of finger prominence will sense bigger pressure than other region. In that way, pressure sensor can be set in this region to sense pressure. When a user uses his left hand to hold phone, as to the back of the mobile terminal, bigger pressure signal will be sensed in the lower and left part region, so pressure sensor can be set in the back where the position is in lower and left part region, shown as FIG. 3. When a user uses his right hand to hold phone, as to the back of the mobile terminal, bigger pressure signal will be sensed in the lower and right part region, so pressure sensor can be set in the back where the position is in lower and right part region, shown as FIG. 2. It can be understood, usually users use their right hand to hold phone, so pressure sensor can be set in the back where the position is in lower and right part region. Of course, to improve feasibility, the pressure sensor can be set in the back where the position is both in lower and right part region and lower and left part region.

Considering the setting of the pressure sensor in the region as above, when pressure sensor sense bigger pressure signaling, it can determine whether users are in single holding status or not, and further determine whether users are using their right hand or left hand. For example, for the technical proposal shown as FIG. 4, when pressure sensor 002 sense bigger pressure signaling, it can determine that the user is using his right hand holding phones. Comparatively, when pressure sensor 003 sense bigger pressure signaling, it can determine that the user is using his left hand holding phones.

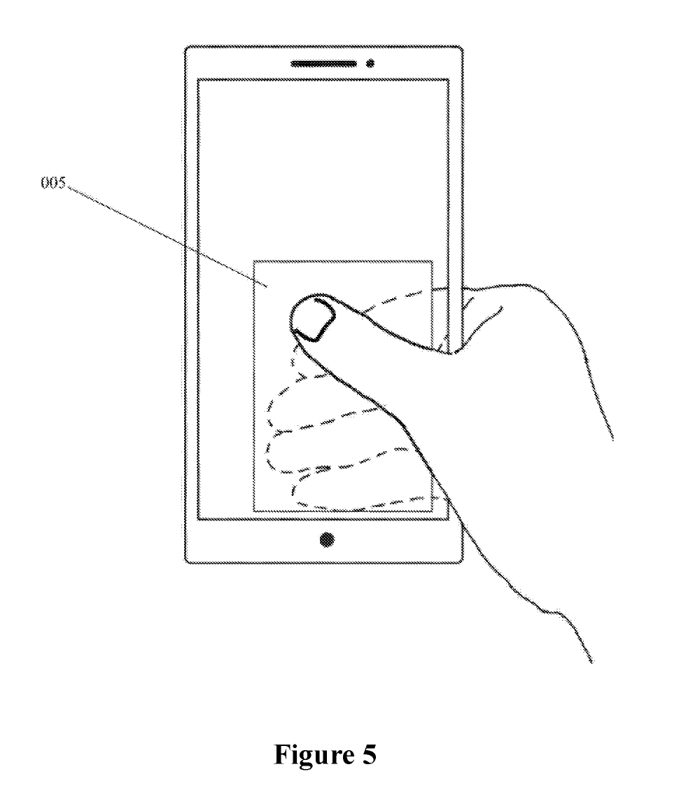

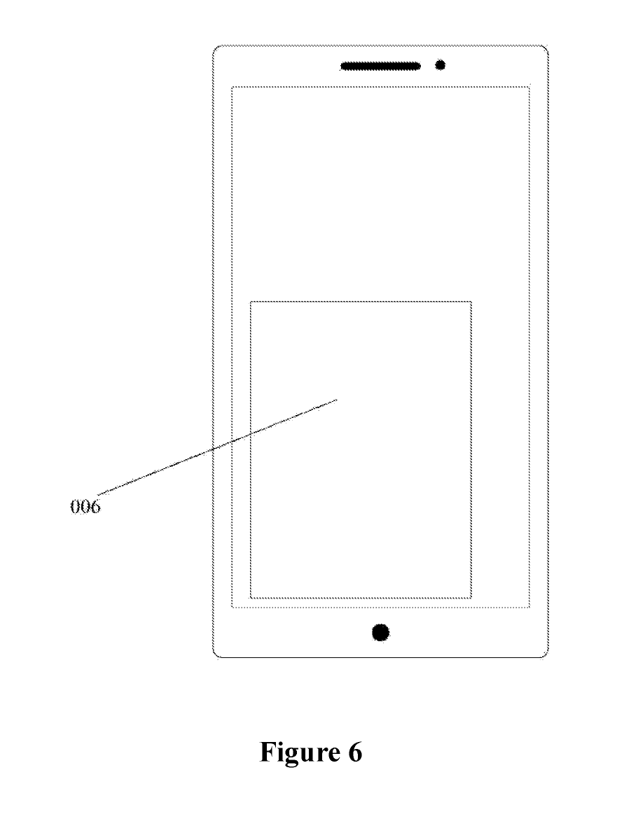

When the users' holding hands of phones are determined, processor can adjust the lighting region of virtual keys and application program icons. When it is right hand, the lighting region of it should be 005 shown in FIG. 5. When it is left hand, the lighting region of it should be 006 shown in FIG. 6.

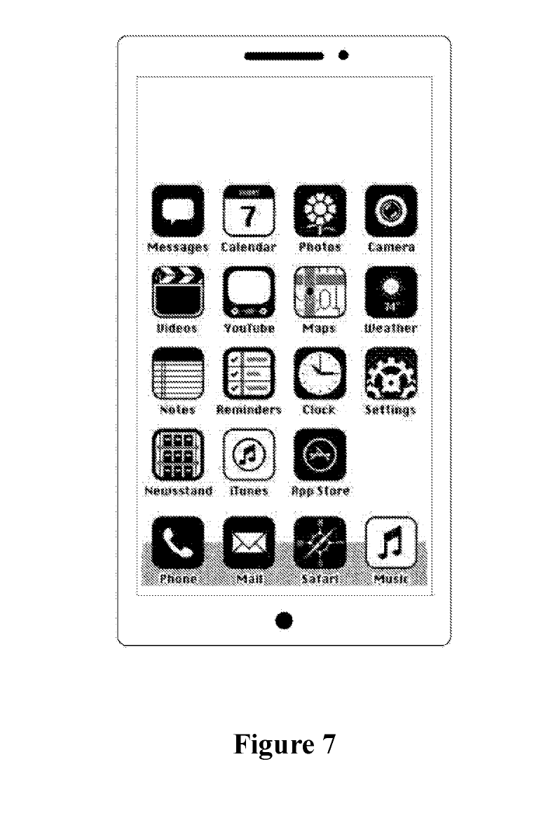

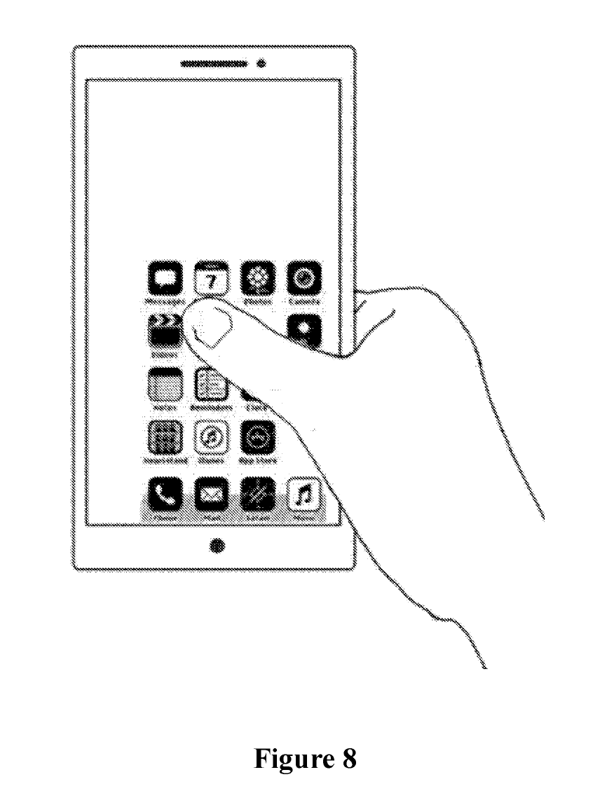

When right hand of a user clenching mobile terminal but not touching and operating the touchscreen, bigger pressure is produced on two broadsides of the mobile terminal, and no pressure or smaller pressure is produced on the back of the mobile terminal. At that time, the lighting region of virtual keys and application program icons are in an original status of the system. For example, most part of the touchscreen is the lighting region of the application program icon, shown as FIG. 7. Then, when the touchscreen is touched or operated by the right hand, such as touching the application program icon of the touchscreen by adjusting a user's right hand posture, the right and lower region of the mobile terminal will sense bigger pressure than other region because the force made by his other four finger prominence except thumb. At that time, the lighting region of the present invention will be changed to the region 005 shown in FIG. 5, and the lighting interface will be the interface shown in FIG. 8.

To be preferred, the pressure sensor is arranged on the back shell of the mobile terminal.

To be preferred, the pressure sensor is arranged on the back mainboard of the mobile terminal.

Further, through-holes are set on the back shell of the mobile terminal. One side of the pressure sensor crosses at them. In that condition, for a user, fingers can touch pressure sensor crossing through-holes to form pressure.

Of course, flexible mechanisms are set on the back shell of the mobile terminal. One side of the pressure sensor faces with them. When a user works on it to form pressure, flexible structure will form shape change, then further works on pressure sensor to form pressure.

Embodiment of the present invention provides a mobile terminal, which at least comprises a touchscreen, a processor and at least one pressure sensor, wherein the pressure sensor is arranged on the back of the mobile terminal. The present invention can adjust a virtual key in the touchscreen and a display region of an application program icon according to a pressure signal sensed by the pressure sensor, so that the virtual key and the application program icon are located in a region facilitating a user in conducting touch control. Therefore, by means of the present invention, it is not necessary for a user to change the posture of his/her hand any longer, so that the user can easily click all virtual keys and application program icons, thereby having good usage experience.

The mobile terminal provided in other Embodiment of the present invention further comprises: gravity sensor, which is linked with the processor. The gravity sensor can sense accelerating signal from mobile terminal, and then send it to processor. The processor can determine the lighting region of the vertical keys and application program icons of the touchscreen according to the pressure signal and accelerating signal.

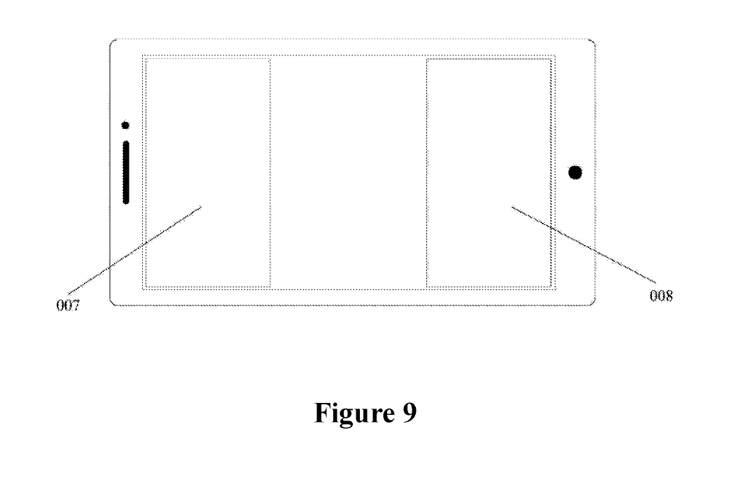

It can be understood, when a user put the mobile terminal in horizontal direction position, and holding two sides separately of the mobile terminal by two hands, the pressure sensor which set on the back of it can also sensor pressure signal. At that time, the lighting region of the vertical keys and application program icons can be determined to be region 007 and region 008 shown in FIG. 9. Because the gravity sensor can sensor the status of the phones, so the processor can determine the lighting region of the vertical keys and application program icons of the touchscreen according to the pressure signal and accelerating signal.

Each Embodiments is described employing corresponding ways, the same and similar parts among them are joining and can be joining each other. And the difference is illustrated among them. The above Embodiments are preferable of the present invention, and should not be understood as a limitation to the present invention. Any modifications, equal adjustments and improvements should be regarded to fall into the scope of the present invention.

1. A mobile terminal, wherein, at least comprises: a touchscreen, a processor and at least one pressure sensor, wherein the processor is separately linked with touchscreen and the pressure sensor, the pressure sensor is arranged on the back of the mobile terminal, specifically is arranged on mainboard or shell of the back, and flexible mechanisms are set in the back shell of the mobile terminal, one side of the pressure sensor faces with them.

2. The mobile terminal according to claim 1, wherein, at least one pressure sensor is arranged in the position of the lower and left part region of the back of the mobile terminal.

3. The mobile terminal according to claim 1, wherein, at least one pressure sensor is arranged in the position of the lower and right part region of the back of the mobile terminal

4. The mobile terminal according to claim 1, wherein, it further comprises:
gravity sensor, which is linked with the processor.

5. The mobile terminal according to claim 2, wherein, at least one pressure sensor is arranged in the position of the lower and right part region of the back of the mobile terminal
